(19) United States
(12) Patent Application Publication
(10) Pub. No.: US 2011/0307572 A1
(43) Pub. Date: Dec. 15, 2011

(54) WIRELESS NETWORK SYSTEM

(75) Inventors: Toru Mugiuda, Minoh-shi (JP); Masaaki Kinoshita, Osaka - shi (JP)

(73) Assignee: Panasonic Electric Works Co., Ltd.

(21) Appl. No.: 13/203,067

(22) PCT Filed: Feb. 22, 2010
(86) PCT No.: PCT/IB2010/000329

§ 371 Date: Aug. 24, 2011

(30) Foreign Application Priority Data
Feb. 24, 2009 (JP) 2009-040971

(51) Int. Cl. G06F 15/16

(52) U.S. Cl. 709/208

(57) ABSTRACT

There is introduced a wireless network system which can establish a complicated wireless network without cumbersome tasks. Arranged hierarchically, wireless terminal a is wire-connected to a master apparatus M, and wireless terminals b, c, d, e, f, g, h, and the like are wire-connected to slave apparatuses A, B, C, D, E, F, G, H, I, and the like. Wireless terminal a outputs a command outputted from the master apparatus M to wireless terminals c and the like whose ranks are immediately below that of the wireless terminal a. Wireless terminal c transmits the command directly or indirectly to wireless terminals d and the like whose ranks are immediately below that of the wireless terminal c. Wireless terminal d communicates with slave apparatus B through a wire, and returns a response from the slave apparatus B to the master apparatus M via wireless terminal c and wireless terminal a.

### FIELD OF THE INVENTION

The present invention relates to a master-slave type wireless network system in which a master apparatus controls to make a slave apparatus perform a command such as read, write or the like, e.g., as in RS485 communications.

### BACKGROUND OF THE INVENTION

Conventionally, there is known a wireless system including a repeater between a wireless terminal connected to a master apparatus and a wireless terminal connected to a slave apparatus (see, e.g., Patent Document 1). This technique is effective in reducing communications traffic when direct communications between the master apparatus and the slave apparatus cannot be performed due to a long distance therebetween.
(Patent Document 1: Japanese Patent Application Publication No. 2007-274303)

In the technique described in Patent Document 1, a user needs to set the wireless terminals used to wirelessly connect the master apparatus to the slave apparatus. This makes it complicated to establish a network.

### SUMMARY OF THE INVENTION

In order to solve the above problems, the present invention provides a wireless network system capable of establishing a wireless network without cumbersome tasks.

In claim 1, there is provided a wireless network system including: a wireless terminal wire-connected to a master apparatus; and one or more wireless terminals each of which is wire-connected to one or more slave apparatuses, wherein the master apparatus transmits a command for a specific one of the slave apparatuses to the wireless terminal wire-connected to the master apparatus; the wireless terminal wire-connected to the master apparatus transmits directly or indirectly to the other wireless terminals a first signal in which ID of the wireless terminal wire-connected to the master apparatus is added to the command from the master apparatus; the wireless terminals receiving the first signal store the ID included in the first signal, extract the command from the first signal, and output the command to the corresponding slave apparatuses; the specific slave apparatus performs the command outputted from the wireless terminal wire-connected thereto and returns a response to the wireless terminal wire-connected thereto; the wireless terminal connected to the specific slave apparatus outputs directly or indirectly the response from the specific slave apparatus to the wireless terminal wire-connected to the master apparatus based on the ID of the first signal; and the wireless terminal wire-connected to the master apparatus outputs the response to the mater apparatus.

In claim 2, the wireless terminal wire-connected to the specific slave apparatus obtains a second signal by adding its own ID to the response outputted from the specific slave apparatus, and outputs directly or indirectly the second signal to the wireless terminal wire-connected to the master apparatus, and the wireless terminal wire-connected to the master apparatus extracts the response from the second signal, outputs the response to the master apparatus, and stores the ID included in the second signal.

In claim 3, when the wireless terminal wire-connected to the master apparatus fails to receive the second signal, the wireless terminal wire-connected to the master apparatus erases the previously stored ID of the wireless terminal wire-connected to the specific slave apparatus.

In claim 4, there is provided a wireless network system including: a single main wireless terminal wire-connected wire to a master apparatus; and a plurality of sub wireless terminals each of which is wire-connected to one or more slave apparatuses and performs wireless communications with the main wireless terminal, wherein the sub wireless terminals are arranged below the main wireless terminal in rank; the master apparatus transmits a command for a specific one of the slave apparatuses to the main wireless terminal; the main wireless terminal transmits directly or indirectly the command outputted from the master apparatus to all the sub wireless terminals; the sub wireless terminals receiving the command outputs the command to the corresponding slave apparatuses wire-connected thereto; the specific slave apparatus performs the command outputted from the sub wireless terminal wire-connected thereto and returns a response to the sub wireless terminal wire-connected thereto; the sub wireless terminal wire-connected to the specific slave apparatus transmits directly or indirectly to the main wireless terminal the response outputted from the specific slave apparatus; and the main wireless terminal outputs the received response to the master apparatus.

In claim 5, the sub wireless terminal wire-connected to the specific slave apparatus obtains a second signal by adding its own ID to the response outputted from the specific slave apparatus, and transmits the second signal directly or indirectly to the main wireless terminal; and the main wireless terminal extracts the response from the second signal, outputs the response to the mater apparatus, and stores the ID included in the second signal.

In claim 6, when the main wireless terminal fails to receive the second signal from the sub wireless terminals, the main wireless terminal erases the previously stored ID of the wireless terminal wire-connected to the specific slave apparatus.

### EFFECTS OF THE INVENTION

With the invention set forth in claim 1, the wireless communications between the master apparatus and the slave apparatus can be carried out without requiring for a user to set which of the wireless terminals is connected to the master apparatus and which to the slave apparatus in the wireless network. As a consequence, a wireless network can be easily established without cumbersome tasks. Moreover, since the wireless terminals store the ID included in the first signal, it is possible to identify the wireless terminal sending the first signal based on the ID. As a result, a response from the slave apparatus can be returned to the wireless terminal that has sent the first signal.

With the invention set forth in claim 2, the wireless terminals connected with wires to the master apparatus can recognize which wireless terminal is connected through a wire to the slave apparatus corresponding to the command based on the stored ID. Hence, when the master apparatus issues a command to the same slave apparatus later, the first signal is transmitted only through the path including the wireless terminal to which the slave apparatus is wire-connected. Accordingly, the wireless communications traffic can be reduced.

With the invention set forth in claim 3, the wireless terminal wire-connected to the master apparatus erases the stored ID when the second signal is not received from the wireless terminal wire-connected to the slave apparatus. Therefore, even when the slave apparatus connected to the wireless terminal is changed, it is not necessary to reconstruct the wireless connection. Accordingly, the wireless network can be easily managed.

With the invention set forth in claim 4, the wireless communications between the master apparatus and the slave apparatuses can be carried out without requiring for a user to set the connection between the slave apparatuses and the wireless terminals in the wireless network. Accordingly, a wireless network can be easily established without cumbersome tasks. Further, the wireless terminal connected to the master apparatus outputs the command from the mater apparatus to the wireless terminal connected to the slave apparatus without adding ID to the command. Hence, compared to the invention set forth in claim 1, the length of the packet used in the wireless communications between the wireless terminal connected to the master apparatus and the wireless terminal connected to the slave apparatus and that between the wireless terminals connected to the slave apparatuses can be shortened, and the communications speed can be increased.

With the invention set forth in claim 5, the traffic congestion of the wireless communication can be reduced.

With the invention set forth in claim 6, the wireless network can be easily managed.

### BRIEF DESCRIPTION OF THE DRAWINGS

FIG. 1 shows a structure of a wireless network system in accordance with an embodiment of the present invention.

FIG. 2 illustrates communications procedures between a master apparatus M and a slave apparatus A in the case of outputting a command from the master apparatus M to a slave apparatus B.

FIG. 3 represents communications procedures between a master apparatus M and a slave apparatus B in the case of outputting a command from the master apparatus M to the slave apparatus B.

FIG. 4 depicts communications procedures between a master apparatus M and a slave apparatus C in the case of outputting a command from the master apparatus M to the slave apparatus B.

### DETAILED DESCRIPTION OF THE EMBODIMENT

### First Embodiment

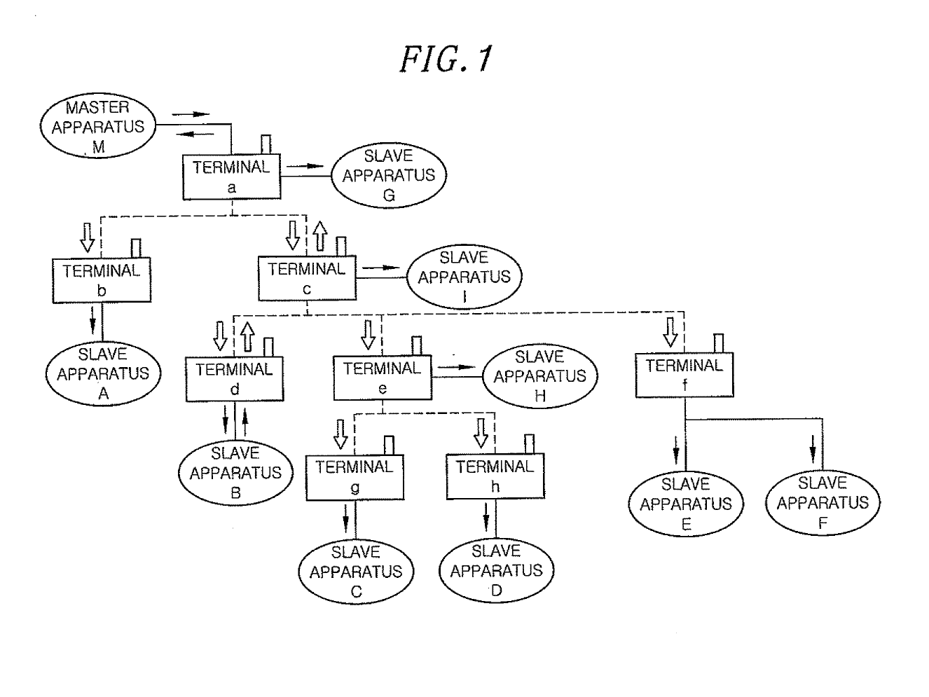

A wireless network system in accordance with a first embodiment of the present invention will be described with reference to the accompanying drawings. FIG. 1 shows a structure of the wireless network system in which communications are performed between a master apparatus M and slave apparatuses A to I. The wireless network system includes a wireless terminal a wire-connected to the master apparatus M, wireless terminals b to h wire-connected to the slave apparatuses A, B, C, D, E, F, H and I, and the like. In the drawing, solid lines indicate wired communications, and dotted lines indicate wireless communications.

The master apparatus M is wire-connected to the wireless terminal a via a single cable. Further, the slave apparatuses A to D are wire-connected to the wireless terminals b, d, g, h via cables, respectively, and the slave apparatuses E and F to the wireless terminal f. The wireless terminals a, b, d, g, h and f have ports for wired input/output of signals. By connecting the cables connected to the master apparatus M and the slave apparatuses A to F to the ports, the wireless terminals a, b, d, g and h are respectively wire-connected to the master apparatus M and the slave apparatuses A to D, and the wireless terminal f is wire-connected to the slave apparatuses E and F.

The master apparatus M sends a command such as a write command, a read command or the like to the slave apparatuses A to I. The slave apparatuses A, B, C, D, E, F, H and I return responses to the command from the mater apparatus M. The command from the master apparatus M is sent to a specific slave apparatus by assigning IDs to the respective slave apparatus. The slave apparatus receives and performs the command including its own ID, and ignores other commands, based on the ID included in the command.

A plurality of master apparatuses may be wire-connected to the wireless terminals. The wireless terminal a wirelessly communicates with the wireless terminals b and c. In other words, the wireless terminal a processes the command transmitted from the master apparatus M and outputs the processed command to the wireless terminals b and c. Moreover, the wireless terminal a has a port for wire-connecting to a slave apparatus. The slave apparatus G is connected to the wireless terminal a through a wire when necessary.

The wireless terminals b to h are hierarchically arranged below the wireless terminal a. In the present embodiment, among the wireless terminals b to h, the wireless terminal closer to the wireless terminal a wire-connected to the master apparatus is set to a higher rank wireless terminal the others. Each of the wireless terminals b to h has a port for wire-connecting to the slave apparatus. The slave apparatus A is wire-connected to the wireless terminal b. The wireless terminal c wirelessly communicates with the wireless terminals a, d, e, f.

The slave apparatus I is wire-connected to the wireless terminal c when necessary. The slave apparatus B is wire-connected to the wireless terminal d; the slave apparatus H is wire-connected to the wireless terminal e; and the slave apparatuses E and F are wire-connected to the wireless terminal f. The wireless terminal e wirelessly communicates with the wireless terminals c, g and h. In addition, the slave apparatus C is wire-connected to the wireless terminal g; and the slave apparatus D is wire-connected to the wireless terminal h.

Hereinafter, an operation of each terminal in the case of performing communications between the master apparatus M and the slave apparatus B will be described as an example of the communications in the wireless network system. The master apparatus M outputs a command to the slave apparatus B and the command is transmitted to each of the slave apparatuses A to I via the wireless terminals a to h. Among the slave apparatuses A to I, only the slave apparatus B corresponding to the command outputted from the master apparatus M performs the command and returns a response. The wireless terminal d processes the response outputted from the slave apparatus B, and transmits it to the master apparatus M via the wireless terminals c and a in that order.

The command outputted from the master apparatus M to the slave apparatus B may be, e.g., RS485 command. For example, a command “Output data stored in X address of an internal memory of the slave apparatus B to the master apparatus M” may be outputted. Upon receiving the command, the slave apparatus B outputs data stored in the X address to the wireless terminal d and the data is transmitted to the master apparatus M via the wireless terminals c and a in that order.

Besides, a command “Update data Y stored in the X address of the internal memory of the slave apparatus B to data Z” may be outputted. The slave apparatus B receives the command and updates the data Y stored in the X address to the data Z. Then, the slave apparatus B outputs a signal indicating completion of the command to the wireless terminal d. This signal is transmitted to the master apparatus M via the wireless terminals c and a in that order.

Specifically, the wireless terminal a adds its own ID to the command outputted from the master apparatus M and outputs it as a first signal. The first signal is transmitted to the wireless terminals b, c, d, e, f, g and h sequentially. Each of the wireless terminals b to h receiving the first signal stores the ID contained in the first signal and refers to the ID when the response from the slave apparatuses A to I is transmitted to the master apparatus M.

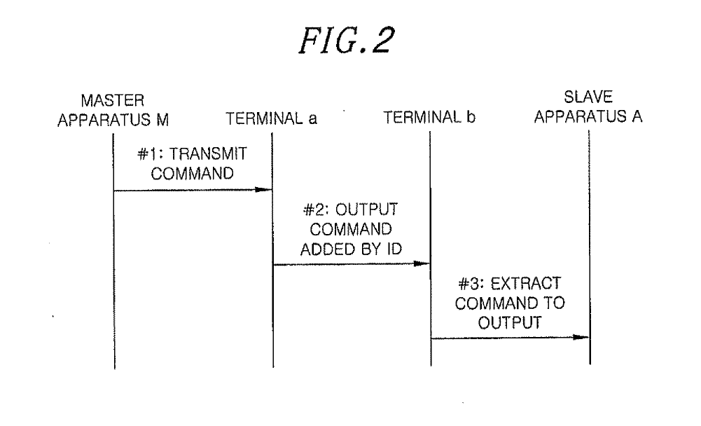

FIG. 2 shows communications procedures between the master apparatus M and the slave apparatus A in the case where the master apparatus M outputs a command to the slave apparatus B. First, the master apparatus M outputs a command to the wire-connected wireless terminal a (#1). Upon receiving the command, the wireless terminal a outputs, to the wireless terminal b, a first signal in which ID of the wireless terminal a is added to the command outputted from the master apparatus M (#2). The wireless terminal b receives the first signal from the wireless terminal a and extracts the command from the first signal to output it to the slave apparatus A (#3). Since this command is destined for the slave apparatus B, it is ignored by the slave apparatus A, and no response is returned from the slave apparatus A.

In the step #3, the wireless terminal b outputs the command to the port thereof regardless of whether or not the slave apparatus B is connected to the wireless terminal b. If the slave apparatus B is not connected to the wireless terminal b, the command is not outputted from the port. In other words, each of the wireless terminals outputs the extracted command to the port thereof regardless of whether or not a specific slave apparatus as a transmission destination is connected to the port. At this time, if other slave apparatus than the specific slave apparatus is connected to the wireless terminal, the command is ignored by the very slave apparatus. Thus, the command is substantially not outputted from the port.

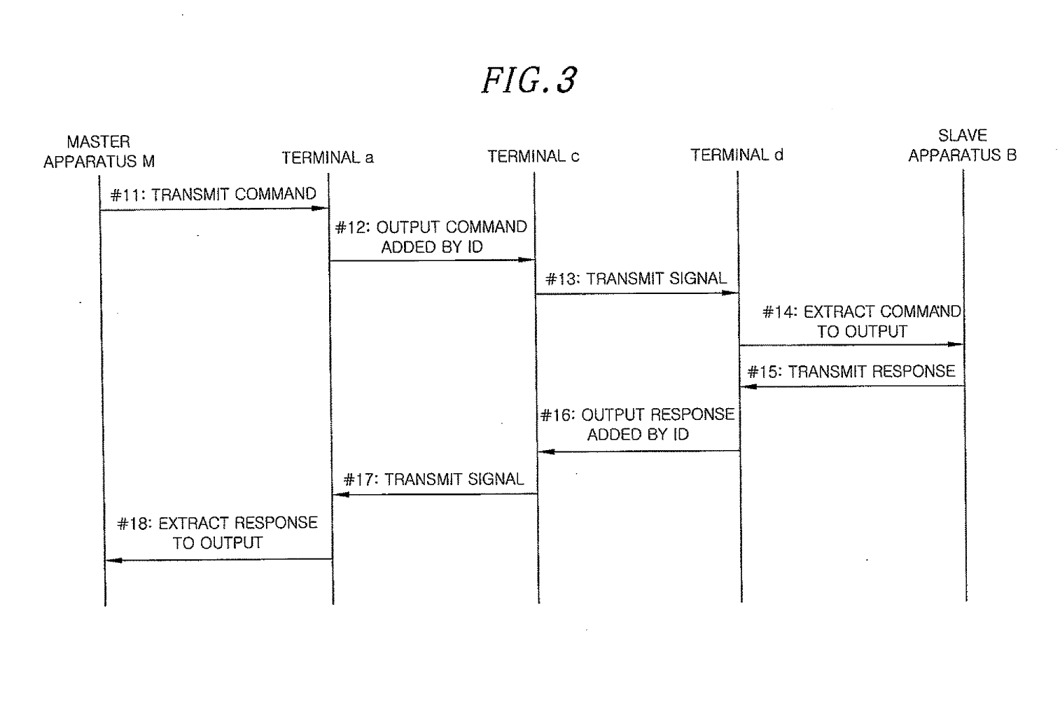

FIG. 3 shows communications procedures between the master apparatus M and the slave apparatus B in the case where the master apparatus M outputs a command to the slave apparatus B. First, as in the step #1, the master apparatus M outputs a command to the wireless terminal a wire-connected thereto (#11). The wireless terminal a receives the command and outputs to the wireless terminal c whose rank is immediately below a first signal in which ID of the wireless terminal a is added to the command outputted from the master apparatus M (#12). In the wireless terminal a, the step #12 is performed in the same manner as the step #2. Upon receiving the first signal, the wireless terminal c transmits the first signal to the wireless terminal d whose rank is immediately below that of the wireless terminal c (#13). The wireless terminal d receives the first signal from the wireless terminal c and extracts the command from the first signal to output it to the slave apparatus B (#14).

Since this command is destined for the slave apparatus B, the slave apparatus B performs the command and returns a response to the wireless terminal d (#15). The wireless terminal d receives the response from the slave apparatus B and outputs to the wireless terminal c whose rank is immediately above that of the wireless terminal d a second signal in which ID of the wireless terminal d is added to the response (#16). Next, the wireless terminal c receives the second signal from the wireless terminal d and transmits the second signal to the wireless terminal a whose rank is immediately above that of the wireless terminal c (#17). Upon receiving the second signal, the wireless terminal a extracts the response from the second signal and sends the response to the master apparatus M (#18). Further, the wireless terminal a stores ID of the wireless terminal d included in the second signal. In the step #14, the wireless terminal d outputs the command to the port thereof regardless of whether or not the slave apparatus B is connected to the wireless terminal d as in the step #3.

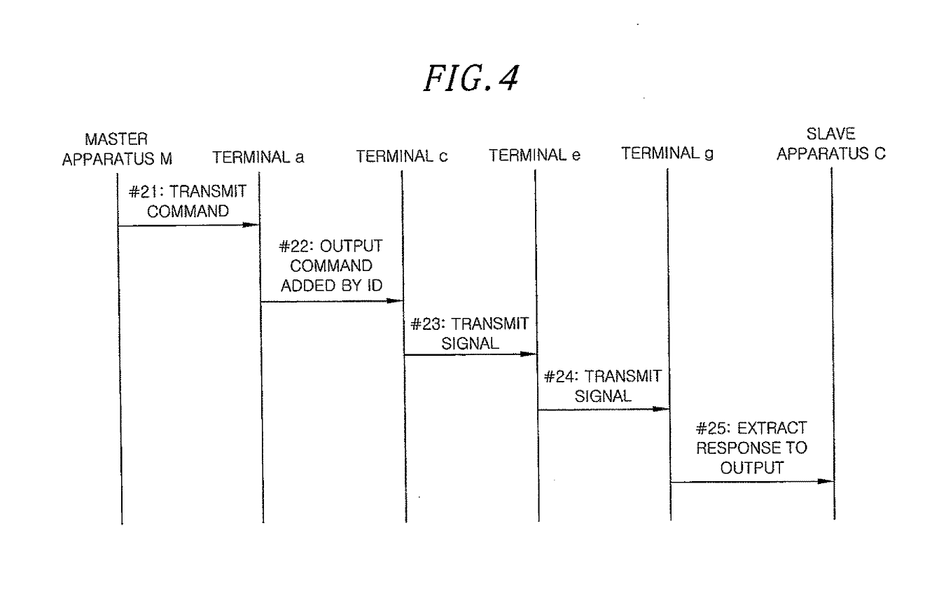

FIG. 4 shows communications procedures between the master apparatus M and the slave apparatus C in the case where the master apparatus M outputs a command to the slave apparatus B. First, as in the step #1, the master apparatus M outputs a command to the wireless terminal a wire-connected thereto (#21). As in the step #12, the wireless terminal a receives the command and outputs to the wireless terminal c whose rank is immediately below that of the wireless terminal a a first signal in which ID of the wireless terminal a is added to the command transmitted from the master apparatus M (#22). Upon receiving the first signal, the wireless terminal c transmits the first signal to the wireless terminal e whose rank is immediately below that of the wireless terminal c (#23). In the wireless terminal c, the step #23 is performed in the same manner as the step #13.

Next, the wireless terminal e receives the first signal from the wireless terminal c and transmits it to the wireless terminal g whose rank is immediately below that of wireless terminal e (#24). Upon receiving the first signal, the wireless terminal g extracts the command from the first signal and outputs it to the slave apparatus C (#25). Since this command is destined for the slave apparatus B, it is ignored by the slave apparatus C, and no response is returned from the slave apparatus C. In the step #25, the wireless terminal g outputs the command to the port thereof regardless of whether or not the slave apparatus B is connected thereto as in the step #3.

The communications between the master apparatus M and the slave apparatuses D to F in the case where the master apparatus M outputs a command to the slave apparatus B are performed in sequence similar to the above-described sequence. The first signal outputted from the wireless terminal a is transmitted directly or indirectly to the wireless terminals b to h. Further, the communications between the master apparatus M and the slave apparatuses A to I in the case where the master apparatus M outputs commands to the respective slave apparatuses A to I are also performed in sequence similar to the above-described sequence.

For example, the wireless terminal a receives the command from the master apparatus M and outputs it to the slave apparatus G. Moreover, the wireless terminal a sends to the wireless terminal c the first signal including the command and ID of the wireless terminal a. Upon receiving the first signal from the wireless terminal a, the wireless terminal c extracts the command from the first signal and outputs it to the slave apparatus I. In the same manner, the wireless terminal e receives the first signal from the wireless terminal c, extracts the command from the first signal and outputs the command to the slave apparatus H.

When the wireless terminal a receives the second signal from the wireless terminal connected to any one of the slave apparatuses, it recognizes which wireless terminal is wire-connected to the very slave apparatus based on the ID included in the second signal. Therefore, when a command is output to the very slave apparatus again, the wireless terminal a outputs the first signal only to the wireless terminals located on the path where the command has been previously transmitted to the wireless terminal to which the very slave apparatus is wire-connected. Specifically, when the master apparatus M outputs a command to the slave apparatus B again after completion of the communications procedures shown in FIGS. 2 to 4, the wireless network system performs only the communications procedures shown in FIG. 3 without performing the communications procedures shown in FIGS. 2 and 4.

When the wireless network system is reconstructed, the slave apparatus B may be disconnected from the wireless terminal d in FIG. 1, for example, and the wireless terminal d and the slave apparatus B may be wire-connected with different slave apparatus and wireless terminal, respectively. In that case, the wireless terminal a does not receive the second signal outputted from the wireless terminal d.

When the wireless terminal a does not receive the second signal from the wireless terminal d, it determines that the wired connection between the slave apparatus B and the wireless terminal d is disconnected, and deletes the stored ID of the wireless terminal d. Then, the wireless network system performs the communications procedures as shown in FIGS. 2 to 4 with respect to all communications paths, and the master apparatus M again communicates with the slave apparatus B to which any one of the wireless terminals is newly wire-connected.

Further, the structure of the wireless network system is not limited to that shown in FIG. 1, and another hierarchical structure may be created. For example, the hierarchical structure of the wireless terminal can be further extended. In that case as well, the wireless terminal a outputs directly or indirectly to the wireless terminal whose rank is immediately below that of the wireless terminal a the first signal in which ID of the wireless terminal a is added to the command transmitted from the master apparatus M. Therefore, any slave apparatus can transmit the response to the master apparatus that has issued the command based on the ID. In addition, the structure of the wireless network system is not limited to a tree shape shown in FIG. 1, and a star-shaped or a mesh-shaped wireless network system may also be employed.

In the present embodiment, although the master apparatus M is connected to the wireless terminal a, it may be connected to any one of the wireless terminals b to h. For example, there will now be described the case in which the master apparatus M is connected to the wireless terminal g and outputs a command to the slave apparatus F.

First, the wireless terminal g outputs to the wireless terminal e whose rank is immediately above that of the wireless terminal g the first signal in which ID of the wireless terminal g is added to the command. Upon receiving the first signal, the wireless terminal e transmits the first signal to the wireless terminal c whose rank is immediately above that of the wireless terminal e and the wireless terminal h whose rank is immediately below that of the wireless terminal e. Further, the wireless terminal c transmits the first signal to the wireless terminal a whose rank is immediately above that of the wireless terminal c and the wireless terminals d and if whose ranks are immediately below that of the wireless terminal c.

The wireless terminal if extracts the command from the received first signal and outputs the command to the slave apparatus F. The first signal is directly or indirectly transmitted from the wireless terminal g connected to the master apparatus to the wireless terminal a and the other wireless terminals b to h. Each of the wireless terminals b to h stores the ID of the wireless terminal g, and the response from the slave apparatus F is directly or indirectly transmitted to the wireless terminal g based on the ID of the wireless terminal g. At this time, the wireless communications are performed through only the wireless terminals on the path between the wireless terminal f and the wireless terminal g.

With the wireless network system in accordance with the present embodiment as described above, the wireless communications between the master apparatus M and the slave apparatuses A to I can be performed without operation of a user for setting connection relationship between the wireless terminals a to h and the master apparatus M and the slave apparatuses A to I. Hence, a wireless network can be easily established without cumbersome tasks. For example, when the present invention is applied to, e.g., a ZigBee wireless network in which a star-shaped, a tree-shaped or a mesh-shaped wireless network is automatically established, a conventional wireless setting becomes unnecessary. Further, the wired network can be replaced with the wireless network simply by arranging the apparatuses.

Moreover, since the wireless terminals a to h store the ID of the wireless terminal connected to the master apparatus, the ID being contained in the first signal, they can specify the wireless terminal transmitting the first signal based on the ID. Hence, the response from one of the slave apparatuses A to I can be returned to the wireless terminal that has transmitted the first signal.

Further, because the wireless terminal (wireless terminal a in FIG. 1) to which the master apparatus M is connected stores the ID of the wireless terminal connected to the slave apparatus which is contained in the second signal, it can recognize which of the wireless terminals is wire-connected to the slave apparatus for which the command is destined based on the stored ID. Accordingly, when the master apparatus M outputs another command to the same slave apparatus again later, the first signal or the command is transmitted only to the wireless terminals on the path getting to the wireless terminal wire-connected to the specific slave apparatus, which reduces the traffic congestion of the wireless communications.

If the second signal is not obtained from another wireless terminal later, the wireless terminal connected to the master apparatus M erases the previously stored ID of the wireless terminal connected to the specific slave apparatus. Therefore, even when the wired connection relationship is changed between the slave apparatus and wireless terminals, the communications can be resumed without resetting the wireless connection by a user. Accordingly, the wireless network can be easily managed.

### Second Embodiment

Next, a wireless network system in accordance with a second embodiment of the present invention will be described. The wireless network system of the second embodiment is different from that of the first embodiment in that a master apparatus is wire-connected only to a single main wireless terminal a. In that case, the second signal containing the response is returned only to the main wireless terminal a, so that it is unnecessary to add the ID of the main wireless terminal.

Therefore, in the steps #2, #12 and #22 of FIGS. 2 to 4, the main wireless terminal a outputs the command from the master apparatus M to the sub wireless terminals b and c as it is without adding ID of the wireless terminal a. The sub wireless terminal c receives the command and transmits it to the sub wireless terminal d and the like. Accordingly, the lengths of the packets used in the wireless communications between the main wireless terminal a and the sub wireless terminals b and c and those among the sub wireless terminals b to h can be shortened, and the communications speed can be increased.

What is claimed is:

1. A wireless network system comprising:
a wireless terminal wire-connected to a master apparatus; and
one or more wireless terminals each of which is wire-connected to one or more slave apparatuses,
wherein the master apparatus transmits a command for a specific one of the slave apparatuses to the wireless terminal wire-connected to the master apparatus;
the wireless terminal wire-connected to the master apparatus transmits directly or indirectly to the other wireless terminals a first signal in which ID of the wireless terminal wire-connected to the master apparatus is added to the command from the master apparatus;
the wireless terminals receiving the first signal store the ID included in the first signal, extract the command from the first signal, and output the command to the corresponding slave apparatuses;
the specific slave apparatus performs the command outputted from the wireless terminal wire-connected thereto and returns a response to the wireless terminal wire-connected thereto;
the wireless terminal connected to the specific slave apparatus outputs directly or indirectly the response from the specific slave apparatus to the wireless terminal wire-connected to the master apparatus based on the ID of the first signal; and
the wireless terminal wire-connected to the master apparatus outputs the response to the master apparatus.

2. The system of claim 1, wherein the wireless terminal wire-connected to the specific slave apparatus obtains a second signal by adding its own ID to the response outputted from the specific slave apparatus, and outputs directly or indirectly the second signal to the wireless terminal wire-connected to the master apparatus, and
the wireless terminal wire-connected to the master apparatus extracts the response from the second signal, outputs the response to the master apparatus, and stores the ID included in the second signal.

3. The system of claim 2, wherein when the wireless terminal wire-connected to the master apparatus fails to receive the second signal, the wireless terminal wire-connected to the master apparatus erases the previously stored ID of the wireless terminal wire-connected to the specific slave apparatus.

4. A wireless network system comprising:
a single main wireless terminal wire-connected to a master apparatus; and
a plurality of sub wireless terminals each of which is wire-connected to one or more slave apparatuses, the sub wireless terminals performing wireless communications with the main wireless terminal,
wherein the sub wireless terminals are arranged such that their respective ranks are lower than that of the main wireless terminal;
the master apparatus transmits a command for a specific one of the slave apparatuses to the main wireless terminal;
the main wireless terminal transmits directly or indirectly the command outputted from the master apparatus to all the sub wireless terminals;
the sub wireless terminals receiving the command outputs the command to the corresponding slave apparatuses wire-connected thereto;
the specific slave apparatus performs the command outputted from the sub wireless terminal wire-connected thereto and returns a response to the sub wireless terminal wire-connected thereto;
the sub wireless terminal wire-connected to the specific slave apparatus transmits directly or indirectly to the main wireless terminal the response outputted from the specific slave apparatus; and
the main wireless terminal outputs the received response to the master apparatus.

5. The system of claim 4, wherein the sub wireless terminal wire-connected to the specific slave apparatus obtains a second signal by adding its own ID to the response outputted from the specific slave apparatus, and transmits the second signal directly or indirectly to the main wireless terminal; and
the main wireless terminal extracts the response from the second signal, outputs the response to the master apparatus, and stores the ID included in the second signal.

6. The system of claim 5, wherein when the main wireless terminal fails to receive the second signal from the sub wireless terminals, the main wireless terminal erases the previously stored ID of the wireless terminal wire-connected to the specific slave apparatus.
